(19) United States
(12) Patent Application Publication
(10) Pub. No.: US 2022/0279991 A1
(43) Pub. Date: Sep. 8, 2022

(54) Integrated Wet Wipe and Disposal Bag Dispenser Unit

(71) Applicant: Tammy Simmons, Seattle, WA (US)

(72) Inventor: Tammy Simmons, Seattle, WA (US)

(21) Appl. No.: 17/505,797

(22) Filed: Oct. 20, 2021

Related U.S. Application Data
(60) Provisional application No. 63/156,650, filed on Mar. 4, 2021.

(51) Int. Cl. A47K 10/46; B65D 83/08; B65F 1/00; B65D 43/16; B65D 25/22; A47K 10/42

(52) U.S. Cl. CPC A47K 10/46; B65D 83/0805; B65F 1/0026; B65D 43/16; B65D 25/22; A47K 10/426; A47K 2010/3266

(57) ABSTRACT

The present invention relates to a combination bathroom wet wipe dispenser and disposal unit, capable of being mounted to the wall near a toilet. The unit stores a replaceable wet wipe dispenser unit and an individual waste bag dispenser unit within a housing. The wet wipe dispenser unit is placed proximal to a front wall of the housing, and an individual wet wipe is dispensed from a slot disposed through a hinged door of the front wall that is aligned with a wipe dispensing slit of the wet wipe dispenser unit. The hinged door can be opened to replace the wet wipe dispenser unit and/or waste bag dispenser unit. The waste bag dispenser unit can be placed proximal to the rear wall of the housing for storing a stack of waste bags, wherein an individual waste bag can be dispensed from the top lid of the housing.

### CROSS-REFERENCE TO RELATED APPLICATION

The present application claims priority to, and the benefit of, U.S. Provisional Application No. 63/156,650, which was filed on Mar. 4, 2021 and is incorporated herein by reference in its entirety.

### FIELD OF THE INVENTION

The present invention relates generally to the field of wipe dispensing systems. More specifically, the present invention relates to an improved wet wipe dispensing and disposal system for toilets. The system provides users with a bathroom wet wipe dispenser and disposal tool used to dispense individual wet wipes for use and application, and individual waste bags for disposing of the used wet wipes. The system features a replaceable container for dispensing individual wet wipes from the front of the system. and an individual waste bag dispenser allowing users to pull out a bag for sealing away used wet wipes for disposal. The system can be placed on a floor or can be mounted to a wall. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals use wet wipes in bathrooms for maintaining personal hygiene. Conventionally, wet wipes are stored in box-like containers that are configured to dispense the wet wipes contained therein. In one hygienic episode or use cycle, individuals may user three to four wet wipes. After using the wet wipes, individuals usually flush the used wet wipes. This is due to their habit of flushing the wipes and also due to the absence of any disposal bag readily available in the bathroom. Individuals sometimes feel embarrassed to openly trash the used wipes and thus are more inclined towards flushing. Therefore, individuals desire a device that readily dispenses wet wipes and also provides for disposal/waste bags for disposing the used wet wipes.

Many of the wet wipes currently available are marketed as flushable, however, they do not disintegrate easily after flushing, and can end up clogging home sewer/septic systems and sewage treatment plants. The aforementioned can lead to serious blockages in the pipes, drains and pumps that can cause sewage back-up in homes and businesses.

Further, the flushed wet wipes can combine with fat, grease and other dirt trapped in the pipes to create an iceberg-like formation also known as fatberg. These formations can create huge clogs in plumbing pipes and drains that are commonly found in houses and other dwellings. Repairing and clearing of such clogs can cost thousands of dollars. Similarly, when wet wipes reach a sewer system they can clog the sewer lines, drains, pumps and septic tanks. The resultant clean-up can cost thousands of dollars, and it is therefore to be avoided by individuals.

All these problems can be eliminated if there exists a device or system that allows/enables individuals to trash the used wet wipes conveniently rather than flushing them.

Therefore, there exists a long felt need in the art for an improved wet wipe dispensing system that enables individuals to dispose of the used wet wipes in a trash receptacle, rather than flushing them. There is also a long felt need in the art for an improved wet wipe dispensing system that eliminates flushing of the wet wipes. Additionally, there is a long felt need in the art for an improved wet wipe dispensing system that provides waste or disposal bags for sealing and disposing of used wet wipes. Moreover, there is a long felt need in the art for an improved wet wipe dispensing system that can be used in association with toilets for maintaining personal hygiene. Further, there is a long felt need in the art for an improved wet wipe dispensing system that saves extensive amounts of money on maintenance and repair of clogged pipes. Furthermore, there is a long felt need in the art for an improved wet wipe dispensing system that makes the disposal bags and wet wipes readily available for application in conjunction with toilets. Finally, there is a long felt need in the art for an improved wet wipe dispensing system that easily and safely dispenses wet wipes for application, and also dispenses disposal bags for sealing used wet wipes for throwing in the trash.

The subject matter disclosed and claimed herein, in one embodiment thereof, comprises a combination bathroom wet wipe dispenser and disposal unit. The unit dispenses individual wet wipes for application and dispenses individual waste bags for hygienic disposal of the used wet wipes in a trash receptacle. The unit features a cuboidal housing that can be placed on a surface or mounted to a wall. The housing includes a cavity formed by a front wall, a pair of side walls, a rear wall, a top lid and a base. The housing can be used for storing a replaceable wet wipe dispensing unit and a replaceable waste bag dispensing unit. The wet wipes are dispensed from the wet wipe dispensing unit, and the waste bags are dispensed from the waste bag dispensing unit.

In this manner, the combination bathroom wet wipe dispenser and disposal unit accomplishes all of the forgoing objectives and provides users with a tool used to dispense individual wet wipes for application and individual waste bags for hygienic disposal of used wet wipes. The replaceable wet wipes dispenser and waste bags dispenser readily provides wet wipes and plastic waste bags. The unit allows individuals to use the wet wipes while in the bathroom, place same in the waste bag and simply throw the waste bag in the trash, rather than flushing the wipes. The unit effectively prevents sewer line clogs, saving extensive amounts of money on maintenance and repairs.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a combination bathroom wet wipe dispenser and disposal unit. The unit can be designed to dispense individual wet wipes for application and can also dispense individual waste bags for disposing of the used wet wipes. The unit further comprises a housing that can be placed on a surface or mounted to a wall. The housing is generally cuboidal in shape and includes a cavity formed by a front wall, a pair of side walls, a rear wall, a top lid and a base, wherein the cavity houses a replaceable wet wipe dispensing unit and a replaceable waste bag dispensing unit. The front wall includes a hinged door that can be opened to replace the replaceable wet wipe dispensing unit and the replaceable waste bag dispensing unit. Further, the door includes a flap from which individual wet wipes can be dispensed from the wet wipe dispensing unit. The top lid can be hinged and hingedly-opened for pulling one waste bag to be used for disposing of the used wet wipes.

In yet another embodiment of the present invention, a wet wipe dispensing and disposing device is disclosed. The device includes a housing comprising of at least a pair of side walls, a rear wall, a front wall, a base surface and a top lid, with the front wall having a hinged door and the top lid pivotally-attached to an edge. The walls, base surface and the lid form a cavity therein to store a wet wipe dispensing unit and a waste bag dispensing unit. The wet wipe dispensing unit stores a set of interfolded wet wipes that are dispensed individually through a slot and flap in the hinged door. The waste bag dispensing unit stores a set of stacked plastic waste bags that are dispensed individually through a top opening accessed by opening the top lid, whereby dispensed waste bags can be used for storing and disposing of the used wet wipe(s) and thereby preventing clogging of sewer lines and related conduits.

In yet another embodiment of the present invention, a wipe disposal device is disclosed. The wipe disposal device includes a wet wipe dispensing container and a plastic waste bag dispensing container. The wet wipe dispensing container includes a dispensing slit, from which the wet wipes are dispensed; the plastic waste bag dispensing container includes an opening through which an individual waste bag is dispensed. The wet wipe dispensing container and the plastic waste bag dispensing container are placed within a housing of the wipe disposal device, wherein the device can be mounted to a wall using an attaching means such as fasteners or adhesive. The housing can include a partition to separate the wet wipe dispensing container and the plastic waste bag dispensing container.

In yet another embodiment of the present invention, a method for disposing used wet wipes by placing the used wet wipes in one or more plastic waste bags is disclosed. The method includes the steps of: pulling out a wet wipe for use from a front side of a wet wipe dispensing and disposing device, then pulling out a plastic waste bag from a top side of the wet wipe dispensing and disposing device, placing the used wet wipe in the individual waste bag pulled from the top side, and throwing the waste bag with the sealed used wet wipe(s) in a trash receptacle, thereby obviating flushing of the used wet wipes and risking a sewer line clog.

In yet another embodiment of the present invention, the disposal device is available in the form of a kit, with a pack of wet wipes dispensing containers and waste bag dispensing containers. The wet wipes dispensing containers can hold the wet wipes in an interfolded or a zig-zag manner.

In yet another embodiment, the wet wipes dispensing container can be placed proximal to the front wall, and the waste bag dispensing container can be placed proximal to the rear wall.

In yet another embodiment of the present invention, the disposal device can be made from a metal, stainless steel, plastic, wood or any other lightweight material. In one embodiment, the wipe dispensing unit can include an integrated slot for storing and dispensing waste bags.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an integrated wet wipe and disposal bag dispenser unit of the present invention in a closed condition in accordance with the disclosed architecture;

FIG. 2 illustrates a perspective view of one potential embodiment of the integrated wet wipe and disposal bag dispenser unit of the present invention in a use condition in accordance with the disclosed architecture;

FIG. 3 illustrates a top perspective view of the integrated wet wipe and disposal bag dispenser unit of the present invention in accordance with the disclosed architecture;

FIG. 4 illustrates a perspective view showing a wipe being dispensed from the integrated wet wipe and disposal bag dispenser unit of the present invention in accordance with the disclosed architecture;

FIG. 5 illustrates a perspective view showing a waste bag being pulled from the waste bag dispenser stored in the integrated wet wipe and disposal bag dispenser unit of the present invention in accordance with the disclosed architecture;

FIG. 6 illustrates a perspective view showing how the wipe dispenser 206 is replaced in the integrated wet wipe and disposal bag dispenser unit of the present invention in accordance with the disclosed architecture;

FIG. 7 illustrates a perspective view showing the combined wet wipe and disposal bag dispenser unit of the present invention mounted to a wall in accordance with the disclosed architecture; and

FIG. 8 illustrates a perspective view of another embodiment of wipe dispenser unit that also includes a waste bag dispensing slot wherein the wipe dispenser unit is designed to be placed in the combined wet wipe and disposal bag dispenser unit of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved wet wipe dispensing system that enables individuals to dispose of the used wet wipes in a trash receptacle, rather than flushing them. There is also a long felt need in the art for an improved wet wipe dispensing system that eliminates the flushing of the wet wipes. Additionally, there is a long felt need in the art for an improved wet wipe dispensing system that provides waste or disposal bags for sealing and disposing of used wet wipes. Moreover, there is a long felt need in the art for an improved wet wipe dispensing system that can be used in association with toilets for maintaining personal hygiene. Further, there is a long felt need in the art for an improved wet wipe dispensing system that saves extensive amounts of money on maintenance and repair of clogged pipes. Furthermore, there is a long felt need in the art for an improved wet wipe dispensing system that makes the disposal bags and wet wipes readily available for application in conjunction with toilets. Finally, there is a long felt need in the art for an improved wet wipe dispensing system that easily and safely dispenses wet wipes for application and also dispenses disposal bags for sealing used wet wipes for throwing in the trash.

The present invention, in one exemplary embodiment, is a wipe disposal device. The wipe disposal device includes a replaceable wet wipe dispensing container and a replaceable plastic waste bag dispensing container. The wet wipe dispensing container includes a dispensing slit from which the wet wipes are dispensed, the plastic waste bag dispensing container includes an opening through which an individual waste bag can be dispensed, the wet wipe dispensing container and the plastic waste bag dispensing container are placed within a housing of the wipe disposal device, wherein the device can be mounted to a wall using an attaching means such as fasteners or adhesive. The housing can include a partition to separate the wet wipe dispensing container and the plastic waste bag dispensing container.

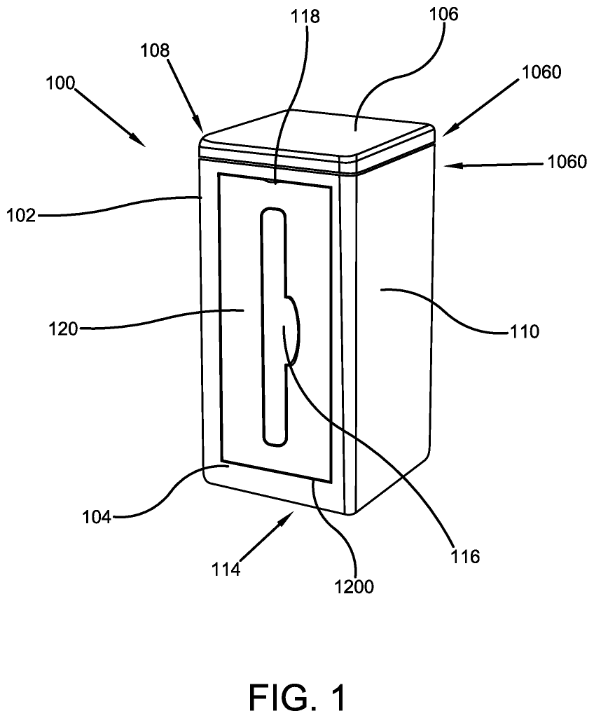

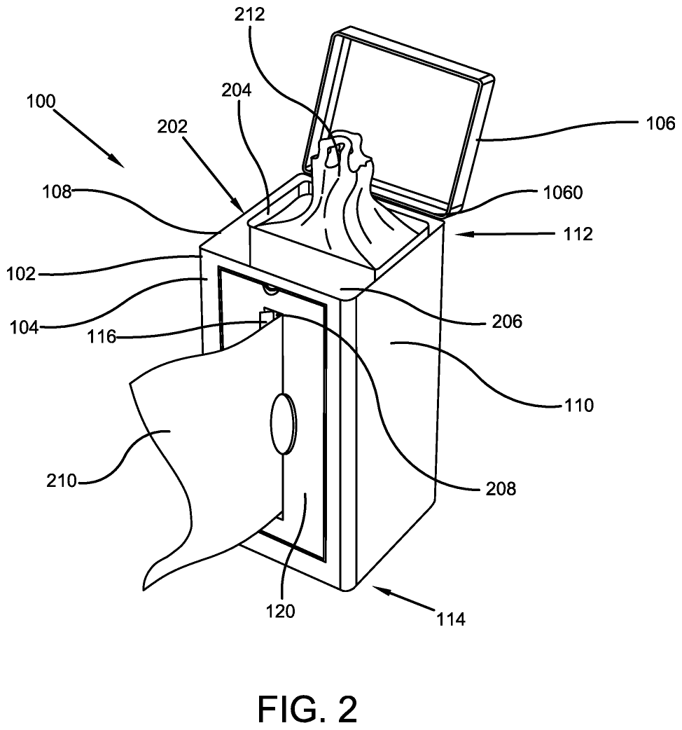

Referring initially to the drawings, FIG. 1 illustrates a perspective view of one potential embodiment of the integrated wet wipe and disposal bag dispenser unit of the present invention in a closed condition in accordance with the disclosed architecture. The integrated wet wipe and disposal bag dispenser unit 100 of the present invention is designed to allow users to dispense wet wipes during use of the toilet, and also dispense waste bags for disposing of the used wet wipes. Thus, the dispenser unit 100 eliminates the flushing of the used wet wipes, thereby preventing clogging of the sewer unit. More specifically, the dispenser unit 100 includes a substantially cuboidal housing 102 that includes a front wall 104, a hinged top lid 106, a right side wall 108, a left side wall 110, a rear wall 112 and a bottom surface 114. The walls 104, 108, 110, 112 extend vertically from the bottom surface 114 and create a cavity therein to store a wet wipe dispenser unit and a waste bag dispenser unit as shown in FIG. 2. The front wall 104 includes an opening covered by a door 120 that can be opened to access the stored wet wipe dispenser unit and the waste bag dispenser unit. The door 120 is hinged at the bottom edge 1200 and includes a finger hole 118 that allows a user to open the door 120 along the hinged edge 1200. The door 120 includes a flap 116 through which a wet wipe is accessed by the user. The flap 116, when not in use for dispensing the wet wipe/tissue, prohibits air from entering the housing 102, and thus prevents the stored wet wipes from contamination and evaporation.

The top lid 106 is hinged and can be pivotally-opened along the hinged edge 1060 to access the waste bag dispenser for dispensing or pulling a single waste bag. It should be appreciated that the waste bags can alternatively be pulled from any of the side surfaces of the housing 102 as described later in the disclosure. The housing 102 is designed to be kept on a surface or can be mounted to a wall. The housing 102 can be made up of a lightweight yet sturdy material such as metal, plastic, wood or the like. Using the front door 120 and/or the top lid 106, both the wet wipe dispensing unit and the waste bag dispensing unit can be replaced easily.

FIG. 2 illustrates a perspective view of one potential embodiment of the integrated wet wipe and disposal bag dispenser unit of the present invention in a use condition in accordance with the disclosed architecture. The housing 102 includes a cavity 202 formed by the walls 104, 108, 110, 112, top lid 106 and the base 114 that stores a waste bag dispenser 204 and a wet wipe dispenser unit 206. Both the waste bag dispensing container 204 and the wet wipe dispensing container 206 are dimensioned as per the housing 102, and preferably the cavity 202 includes a partition (not shown) to securely position the wipe dispensing unit 206 and the waste bag dispensing unit 204. During use, when a wipe is to be used, a first wipe 210 is pulled from the front door 120 by slightly pulling the flap 116 to create a wipe dispensing slot 208, from which the first wipe 210 is pulled. For accessing a waste bag 212, the top lid 106 is opened along the hinged edge 1060 and a first waste bag 212 is pulled out from the waste bag dispensing unit 204.

The wet wipe dispensing container 206 can store the wet wipes in independently stacked or interleaved formation, enabling dispensing of a single wipe at a time. Further, as the wet wipes supply is depleted, subsequent wet wipe dispensing containers can be used or the existing wet wipe dispensing container can be replenished.

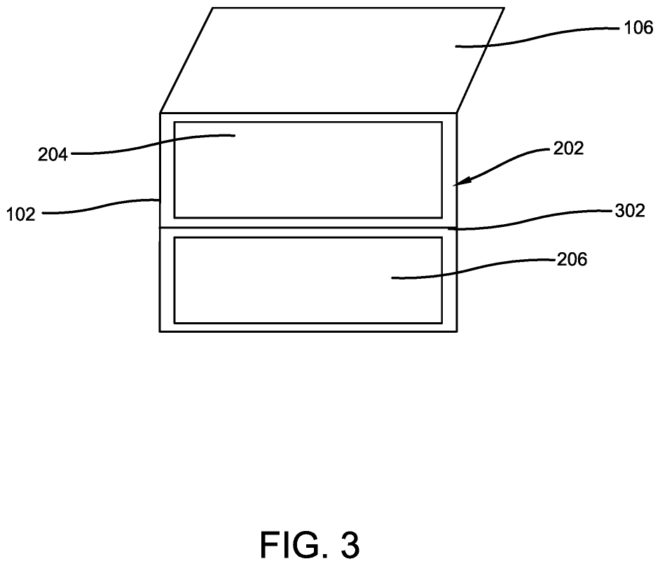

FIG. 3 illustrates a top perspective view of the integrated wet wipe and disposal bag dispenser unit of the present invention in accordance with the disclosed architecture. The cavity 202 of the housing 102 includes a fixed or movable partition 302 to separate and securely place a waste bag dispenser 204 and a wipe dispenser 206. Based on the size of the waste bag dispenser 204 and the wipe dispenser 206, the partition 302 can be adjusted. Preferably, the waste bag dispenser 204 is positioned near the rear wall of the housing 102, and the wipe dispenser 206 is positioned near the front wall of the housing 102. The top lid 106 is designed to be opened to access the waste bags from the waste bag dispenser 204 and the wipes are accessed from the front door.

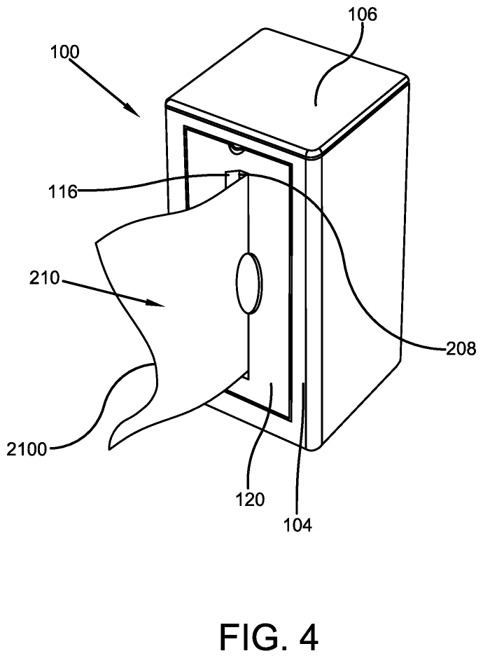

FIG. 4 illustrates a perspective view showing a wipe being dispensed from the integrated wet wipe and disposal bag dispenser unit of the present invention in accordance with the disclosed architecture. From the front door 120 disposed on the front wall 104, a wipe 210 is dispensed. Preferably, the wipes stored in the wipe dispenser unit can be stacked, allowing the trailing edge 2100 of the wipe to always remain accessible when the flap 116 is open to access the wipe dispensing slot 208. It is to be appreciated that for dispensing/pulling the wipe 210, the top lid 106 and also the front door 120 do not need to be opened or accessed.

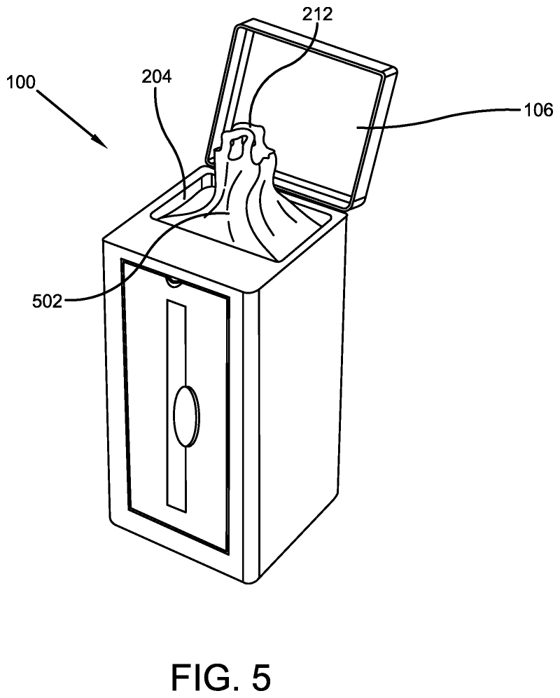

FIG. 5 illustrates a perspective view showing a waste bag being pulled from waste bag dispenser stored in the integrated wet wipe and disposal bag dispenser unit of the present invention in accordance with the disclosed architecture. The dispenser device 100 enables a user to pull one or more waste bags 212 from a stack 502 of waste bags 212 stored in the waste bag dispenser 204 in the device 100. A user can open the top lid 106 and pull one waste bag 212 at a time for disposing of the used wipe(s). The waste bag dispenser 204 can store the waste bags 212 in the stacked form 502, and the waste bags 212 can be coated with an anti-microbial agent for maintaining hygiene and personal safety. Further, the waste bags 212 can include a layer of a scent or any fragrant agent that helps in removing odors from the bathroom. In one potential embodiment, the waste bag dispenser 204 can store hundreds of stacked waste bags.

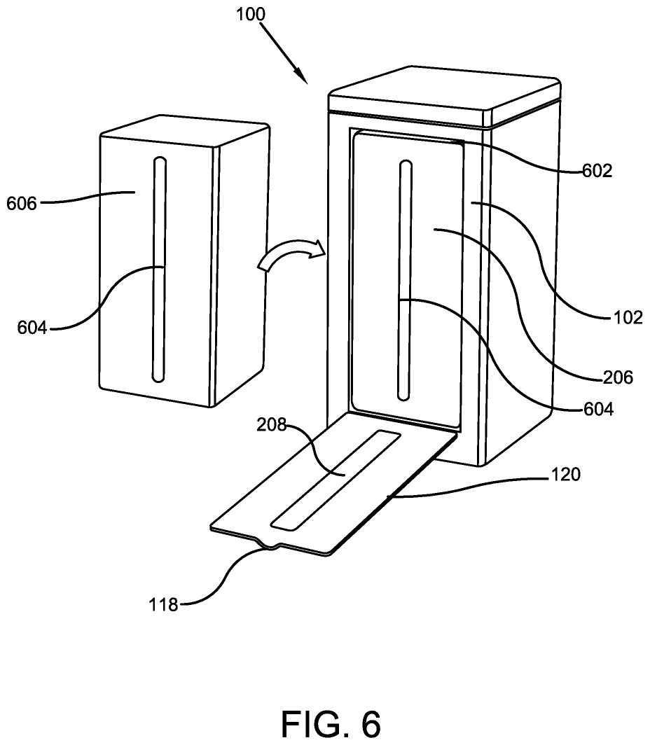

FIG. 6 illustrates a perspective view showing how the wipe dispenser 206 is replaced in the integrated wet wipe and disposal bag dispenser unit of the present invention in accordance with the disclosed architecture. Generally, when the wipes in the wipe dispenser 206 are exhausted, the wipe dispenser 206 can be easily replaced with a new wipe dispenser unit 606 or can be refilled with new wipes. For replacing or refilling the wipe dispenser bag 206, the hinged door 120 is opened using the finger notch 118 to access the front door opening 602. Then, through the opening 602, the depleted stored wipe dispenser 206 is pulled out. When the stored wipe dispenser 206 is pulled, a new wipe dispenser unit 606 can be easily placed within the device 100. For dispensing or enabling a user to easily pullout wipes, each of the wipe dispenser unit 206, 606 includes a wipe slit 604 from which the wipes are accessible. The wipe dispensing slot 208 disposed on the front door 120 and the wipe slit 604 align with each other when the wipe dispenser unit 206 is placed in the device 100, thereby allowing the user to pull the wipe for use even when the front door 120 of the device 100 is closed as illustrated in FIG.3.

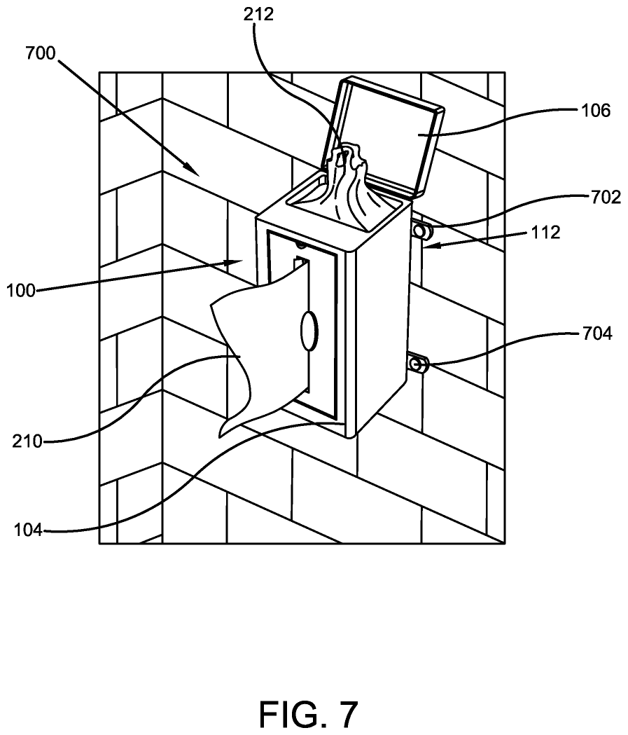

FIG. 7 illustrates a perspective view showing the combined wet wipe and disposal bag dispenser unit of the present invention mounted to a wall in accordance with the disclosed architecture. Advantageously, the wipe disposal device 100 can be placed on any flat surface in a bathroom (i.e. near a toilet) or can be mounted to a toilet wall 700. The wipe disposal device 100 can be mounted to the wall 700 using fasteners such as a first fastener 702 and a second fastener 704. It should be noted that more than two fasteners can be used for mounting the device 100 to the wall 700. Alternatively, any other means, such as an adhesive, can be used for mounting the device 100 to the wall 700. The fasteners are preferably attached to the rear wall 112, and the wipes 210 are dispensed from the front wall 104. Further, the waste bag 212 can be pulled by opening the top lid 106.

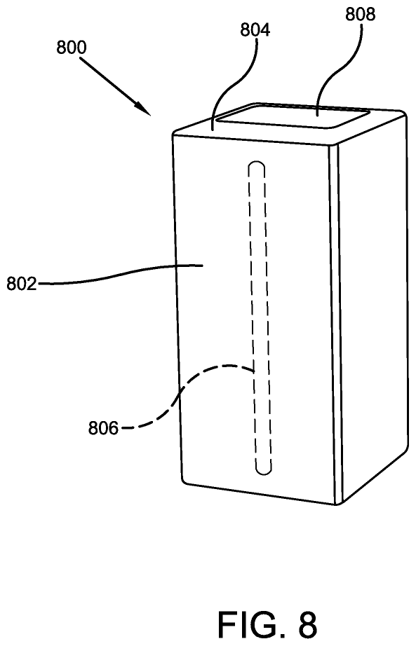

FIG. 8 illustrates a perspective view of another embodiment of the wipe dispenser unit that also includes a waste bag dispensing slot, wherein the wipe dispenser unit is designed to be placed in the combined wet wipe and disposal bag dispenser unit of the present invention in accordance with the disclosed architecture. In the present embodiment, the wipe dispenser unit 800 includes a wipe dispensing slit 806 for dispensing wipes from the front surface 802, but also includes a waste bag dispensing slot 808 on the top surface 804. The wipe dispenser unit 800 can store both the fresh wet wipes and waste bags, thus eliminating the use of two separate dispenser units to be stored in the wipe disposal device 100 of the present invention.

For exemplary purposes, it is contemplated that the wipe dispensing container can store anywhere between 50-100 wet wipes and the waste bag dispensing container can store anywhere between 20-80 disposal bags, and such selection is based on calculations including ariables such as the size of the dispensing units, size of the tissues (square, rectangular, pocket size, oversize, etc.), size of the waste bags and other variables that the skilled artisan would consider relevant.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “combined wet wipe and disposal bag dispenser unit”, “wipe disposal device”, “device”, and “integrated wet wipe and disposal bag dispenser unit”, are interchangeable and refer to the integrated wet wipe and disposal bag dispenser unit 100 of the present invention.

Notwithstanding the forgoing, the integrated wet wipe and disposal bag dispenser unit 100 of the present invention can be of any suitable size and configuration as is known in the art without affecting the overall concept of the invention, provided that it accomplishes the above-stated objectives. One of ordinary skill in the art will appreciate that the size, configuration and material of the integrated wet wipe and disposal bag dispenser unit 100 as shown in the FIGS. are for illustrative purposes only, and that many other sizes and shapes of the integrated wet wipe and disposal bag dispenser unit 100 are well within the scope of the present disclosure. Although the dimensions of the integrated wet wipe and disposal bag dispenser unit 100 are important design parameters for user convenience, the integrated wet wipe and disposal bag dispenser unit 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wet wipe and disposal bag dispenser unit comprising:
a housing including a front wall, a right side wall, a left side wall, a rear wall, and a bottom surface;
said front wall, said right side wall, said left side wall, and said rear wall extending vertically from said bottom surface to create a cavity therein for storing a wet wipe dispenser unit and a waste bag dispenser unit;
said front wall includes an opening covered by a door selectively openable to access said wet wipe dispenser unit; and
said door includes a flap through which an individual wet wipe is accessed by a user, wherein said flap when not in use for dispensing said individual wet wipe prohibits air from entering said housing.

2. The wet wipe and disposal bag dispenser unit of claim 1 further comprising a hinged top lid for accessing said waste bag dispenser unit.

3. The wet wipe and disposal bag dispenser unit of claim 2, wherein said accessing said waste bag dispenser unit includes accessing an individual waste bag.

4. The wet wipe and disposal bag dispenser unit of claim 3, wherein said housing includes a material selected from a group consisting of a metal, a plastic, and a wood.

5. The wet wipe and disposal bag dispenser unit of claim 3, wherein said housing mounted to a wall.

6. The wet wipe and disposal bag dispenser unit of claim 2, wherein said wet wipe dispenser unit and said waste bag dispenser unit are replaceable in said housing.

7. The wet wipe and disposal bag dispenser unit of claim 6, wherein said door includes a hinged bottom edge that allows the user to open said door along said bottom edge.

8. The wet wipe and disposal bag dispenser unit of claim 7, wherein said door includes a finger hole that allows the user to grasp said door along said bottom edge.

9. The wet wipe and disposal bag dispenser unit of claim 3, wherein said individual waste bags coated with an anti-microbial agent for maintaining hygiene.

10. The wet wipe and disposal bag dispenser unit of claim 3, wherein said individual waste bags coated with a fragrant agent.

11. A wet wipe and disposal bag dispenser unit comprising:
a housing including a front wall, a right side wall, a left side wall, a rear wall, and a bottom surface;
said front wall, said right side wall, said left side wall, and said rear wall extending vertically from said bottom surface to create a cavity therein for storing a wet wipe dispenser unit and a waste bag dispenser unit;
said front wall includes an opening covered by a door selectively openable to access said wet wipe dispenser unit;
said door includes a flap through which an individual wet wipe is accessed by a user, wherein said flap when not in use for dispensing said individual wet wipe prohibits air from entering said housing;
a hinged top lid for accessing said waste bag dispenser unit, wherein said accessing said waste bag dispenser unit includes accessing an individual waste bag; and
said wet wipe dispenser unit and said waste bag dispenser unit are replaceable in said housing.

12. The wet wipe and disposal bag dispenser unit of claim 11, wherein said housing includes a material selected from a group consisting of a metal, a plastic, and a wood.

13. The wet wipe and disposal bag dispenser unit of claim 11, wherein said housing mounted to a wall.

14. The wet wipe and disposal bag dispenser unit of claim 11, wherein said door includes a hinged bottom edge that allows the user to open said door along said bottom edge.

15. The wet wipe and disposal bag dispenser unit of claim 11, wherein said door includes a finger hole that allows the user to grasp said door along said bottom edge.

16. The wet wipe and disposal bag dispenser unit of claim 11, wherein said individual waste bags coated with an anti-microbial agent for maintaining hygiene.

17. The wet wipe and disposal bag dispenser unit of claim 11, wherein said individual waste bags coated with a fragrant agent.

18. A wet wipe and disposal bag dispenser unit comprising:
a housing including a front wall, a right side wall, a left side wall, a rear wall, and a bottom surface;
said front wall, said right side wall, said left side wall, and said rear wall extending vertically from said bottom surface to create a cavity therein for storing a wet wipe dispenser unit and a waste bag dispenser unit;
said front wall includes an opening covered by a door selectively openable to access said wet wipe dispenser unit;
said door includes a flap through which an individual wet wipe is accessed by a user, wherein said flap when not in use for dispensing said individual wet wipe prohibits air from entering said housing;
a hinged top lid for accessing said waste bag dispenser unit, wherein said accessing said waste bag dispenser unit includes accessing an individual waste bag;
said wet wipe dispenser unit and said waste bag dispenser unit are replaceable in said housing;
said wet wipe dispenser unit includes from about 50 said individual wet wipes to about 100 said individual wet wipes; and
said waste bag dispenser unit includes from about 20 said individual waste bags to about 80 said individual waste bags.

19. The wet wipe and disposal bag dispenser unit of claim 18, wherein said housing mounted to a wall.

20. The wet wipe and disposal bag dispenser unit of claim 18, wherein said individual waste bags coated with an anti-microbial agent for maintaining hygiene.
